(19) United States
(12) Patent Application Publication
(10) Pub. No.: US 2003/0177645 A1
(43) Pub. Date: Sep. 25, 2003

(54) Power tool assembly and associated method of use in rescue situations

(76) Inventors: Franz Flury, Lommiswil (CH); Willi Schnidrig, Grachen (CH); Daniel Grolimund, Zuchwil (CH)

Correspondence Address: Paul J. Maginot, Maginot, Moore & Bowman, Bank One Center/Tower, 111 Monument Circle, Suite 3000, Indianapolis, IN, 46204-5115, US

(21) Appl. No.: 10/358,492

(22) Filed: Feb. 5, 2003

Related U.S. Application Data
(60) Provisional application No. 60/355,416, filed on Feb. 7, 2002.

(51) Int. Cl. B27B 3/12

(52) U.S. Cl. 30/392; 30/355; 30/345

(57) ABSTRACT

A rescue working tool is provided with a luminescent layer on exposed portions of the tool, and preferably over the entirety of the working tool. In a specific embodiment, the working tool is a rescue saw used to cut through debris and mangled structure at a vehicle crash or building collapse site. The luminescent layer can be fluorescent, but is preferably phosphorescent so that the layer emits light when the tool is used in low light or darkness.

This application claims the benefit of U.S. Provisional Application Serial No. 60/355,416, filed Feb. 7, 2002. The disclosure of this provisional patent application is hereby totally incorporated by reference in its entirety.

### BACKGROUND OF THE INVENTION

The invention pertains to tools, such as saws, and most particularly powered tools. More specifically, the invention relates to improvement in tools used for rescuing victims in conditions that require extraction from a collapsed structure.

Technological advance has always presented a double-edged sword. For example, in the field of automobiles, technology has allowed us to travel at higher speeds and over greater distances than ever before. On the other hand, this same technology has made it possible for us to become involved in much more horrific accidents than ever before. Even as automobile accidents are happening with more frequency, the severity and amount of damage generated in these accidents has also steadily increased.

While technology has allowed us to develop safer and stronger cars that are better able to withstand these crashes, these same strengths can be a detriment. More specifically, many cars are designed to buckle so that the structural elements of the vehicle absorb the impact, rather than the occupant. While this technological improvement has saved many lives, automobile passengers are more frequently trapped in the mangled remains of a vehicle that has collapsed around the passenger.

In order to address this type of event, many types of rescue tools have been devised. The most prominent may be the Jaws Of Life® type device. In essence, the Jaws Of Life® is an extraordinarily strong wrench or pry bar which is used to peel back bent and broken parts of a vehicle frame and outer body. The success of the Jaws Of Life® type device has been well documented in the media.

In addition to brut force devices like the Jaws Of Life®, rescue personnel also use a variety of other tools as required by the accident site. For instance, saws are commonly used that are capable of cutting away sheet metal or through structural members of a vehicle frame. Saws of this type are often preferred over a Jaws Of Life® type device in recovering accident victims because they allow for pinpoint dismantling of the crashed vehicle. Saws used in rescue and recovery operations usually have reciprocating blades, although other types of saws may be useful in dealing with more specific types of collapsed structures. In addition, other tools, such as drills or circular saws may be used at a site to assist in extracting an accident victim.

In addition to vehicle crashes, other types of catastrophic events benefit from the improved rescue tools such as the Jaws Of Life® device and the rescue saw. For instance, building or structure collapses can also trap victims within the debris. In collapses of this type, structural beams can often impede the path of rescue workers or prevent the extraction of traumatized victims. As with catastrophic automobile crashes, rescue tools of the type described above have become critical life saving devices.

Of course, the very nature of accidents and catastrophes is that they are not predictable or limited to conditions that are most conducive to rescue operations. Many rescues and life sustaining efforts are hampered not only by the crumpled structure around the victim, but also by the environment. It goes without saying that rescue efforts at night become significantly more complicated because it is difficult to see the structure and debris that needs to be removed. Generator powered high intensity lights can provide sufficient illumination for some accident sites. However, this artificial lighting does not necessarily reach everywhere that rescue efforts must occur. For instance, in a building collapse, there may not be sufficient physical space to accommodate both a rescue worker and adequate remote lighting. In instances like this, the rescue worker often wears a miner's hat with a lamp mounted to the hat. While this is certainly not optimum, it is better than nothing and has been invaluable in allowing rescue workers to access victims at hard to reach locations.

In spite of these technological advancements, there still remains a need for improved capabilities for effecting rescues in low light conditions or even in darkness. The need is particularly acute where the rescue involves cutting through collapsed structures, whether the structure is an automobile or a building. It is in these conditions that the use of tools at the rescue site may be dangerous for the rescuer and victim.

### SUMMARY OF INVENTION

In order to address these needs, the present invention contemplates a tool for rescue operations that has a working portion that is at least partially luminescent. In one particular embodiment, the rescue tool can be a portable power saw. The working portion or blade of the saw is provided with luminescent characteristics. Other tools are contemplated in which the working portion of the tool includes the luminescent feature. This luminescence provides the rescue worker with a visual indication of the location and orientation of the working tool as it is being used. Thus, in the case of a saw blade, the luminescent blade would be visible to the worker, even in total darkness, to the worker can gauge the location and extent of a cutting operation. If the working tool is a drill, the luminescence can provide a visual indication of the depth that the drill bit has penetrated the subject structure.

For illustrative purposes, the preferred embodiment of the invention relates to a reciprocating saw, and particularly to the removable blade of a hand-held rescue saw. In one aspect of the invention, the working portion, or blade, of the saw tool can be provided with a luminescent coating. The coating can be in the form of a lacquer that is applied to the exposed surfaces of the saw blade. Most preferably, the luminescent material is capable of glowing in the dark. The material can be phosphorescent so that it generates a modest amount of light for a predetermined period of time while the saw blade is being used. In a most preferred aspect, the material can be super-phosphorescent so that it continues to glow for an extended period of time to account for a lengthy rescue operation. A typical phosphorescent material for use with the invention can become energized by exposure to light.

In a preferred embodiment, fluorescent or phosphorescent pigments or material can be incorporated into a binder material, such as an enamel or a lacquer fluid. This fluid can then be spray painted onto the surface of the tool, applied through an electrostatic process, or applied by dipping the tool into a vat of enamel or lacquer. In a preferred embodiment, the layer is applied at a thickness of 10-30 micrometers, but is sufficiently thick to accommodate the luminescent component of the material. For instance, some luminescent materials include crystals that provide the luminescent properties. The applied layer must be thick enough to substantially entrain the luminescent crystals within the binder material.

In the preferred embodiment, the luminescent is phosphorescent, meaning that it emits light when in its excited state. Thus, the phosphorescent layer can be illuminated even when the tool is used in total darkness. In certain embodiments, the phosphorescent material can be capable of emitting sufficient light to provide some illumination to the working site.

In alternative embodiments, the luminescent material is fluorescent, meaning that it glows when light strikes the layer. This embodiment can have application where the tool is used in low light conditions. In this case, the fluorescent layer will provide a visual indication of the placement and positioning of the working tool.

In one aspect of the invention, the entirety of the working portion of the tool is provided with the luminescent layer. In the case of a removable saw blade, the entire flat side surfaces, and even the thin edges, of the blade can be coated with the luminescent material. Thus, the entire working portion of the tool can be visible during a rescue operation.

Moreover, depending on the nature of the luminescent material. The tool itself may shed some light on the work area. With this feature of the invention, a rescue worker knows exactly where the rescue tool is, how it is positioned, and what it is cutting. The luminescent cutting blade also allows the rescue operator to deftly manipulate the tool to avoid the victim, for instance, or to make a precision cut in a particular structural element.

In the most preferred embodiment, the entire tool is coated with the luminescent material. In an alternative embodiment, only portions of the tool are coated with the luminescent material. Most preferably, the working end of the tool includes a luminescent coating so that the rescue worker can readily identify the position of the tool during a rescue operation. In addition to providing a luminescent coating at particular areas of the tool, specific lettering or characters can also be applied in a luminescent layer on the tool.

It is a primary object of the invention to provide a tool usable in rescue operations under low-light conditions. A more specific object is accomplished by features of the invention that facilitate use of the tool in total darkness.

One significant benefit of the invention is that it allows a rescue tool to be used virtually anywhere at a rescue site. A further benefit is that the inventive tool can provide a direct visual guide for a rescue worker as to the location and positioning of the tool, as well as the extent of the working operation of the tool. Other objects and benefits of the invention will become apparent upon consideration of the following written description and accompanying figures.

### DESCRIPTION OF THE FIGURES

FIG. 1 is a perspective view of a hand-held power tool, in particular a reciprocating power saw of the type that can be used at a rescue site.

FIG. 2 is a perspective view of a hand-held compass saw that can also have application at a rescue site.

FIG. 3 side elevational view of a cutting blade for a reciprocating such as the tool depicted in FIG. 1 or 2, with the saw blade incorporating a luminescent layer in accordance with one aspect of the current invention.

FIG. 4 is a side elevational view of a reciprocating saw blade that e used with the tools depicted in FIG. 1 or 2, with certain portions of the including a luminescent layer.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

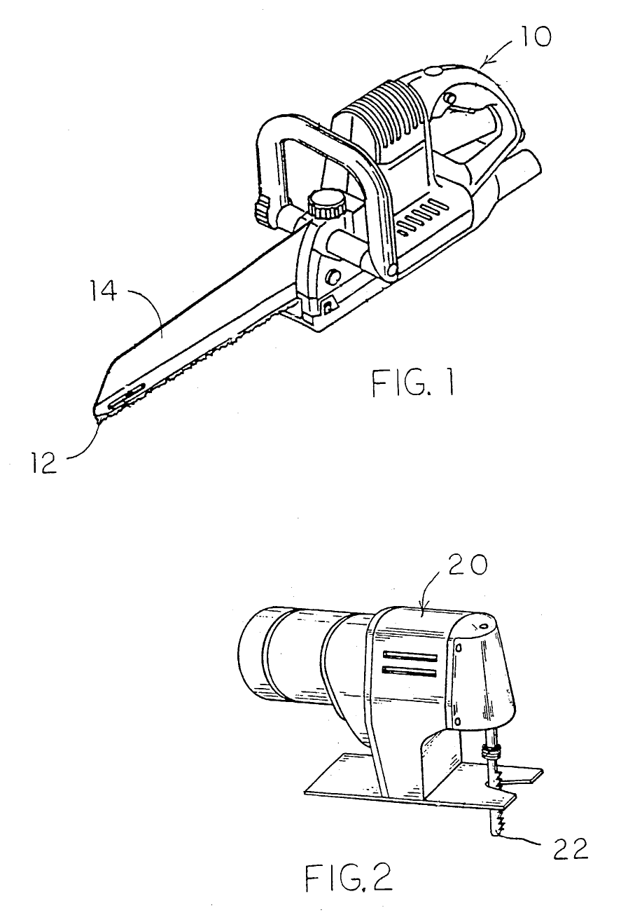

The present invention has application in a variety of tools, but most particularly tools that have intended uses where the area is poorly lit. Most preferably, the invention can be used with tools used for conducting rescue efforts where the victim is trapped within a damaged or buckled structure, such as an automobile or a building. Thus, as shown in FIG. 1, a sword saw 10 is contemplated by the present invention. The sword saw includes a reciprocating saw blade 12 that is guided and shielded by a sword portion 14. A compass saw 20 is depicted in FIG. 2. The compass saw includes a reciprocating blade 22. The two saws 10 and 20 are exemplary of the type of tool that can implement the present invention.

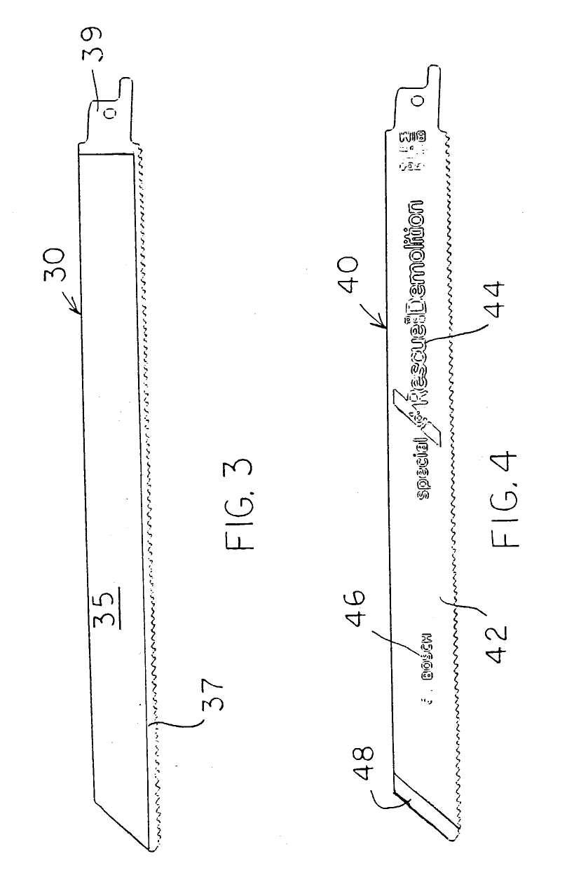

In accordance with this invention, the saw blade, such as blades 12 and 22, is provided with a luminescent coating. Thus as depicted in FIG. 3, a saw blade 30 can include a coating 35 over a substantial portion of the blade. Although the coating 35 is depicted on one side in FIG. 3, it is contemplated that both sides, and even the edges, of the saw blade 30 carry the particular coating.

In one embodiment, the coating can be applied over substantially the entire saw blade 30. For instance, in the specific embodiment shown in FIG. 3, the coating 35 is applied to almost all of the exposed area of the blade. However, the luminescent coating may not be applied to a region 37 adjacent to and including the cutting teeth, or to a region 39 at the chuck engagement end of the blade 30. In both cases, the application of a luminescent coating would provide very little benefit, if any. The portion 39 would be hidden within the powered tool once the removable blade is mounted within the tool chuck. The portion 37 at the cutting teeth would eventually be worn off during a sawing action using the blade 30. In some instances, the application of the luminescent coating on the cutting teeth may even hamper the performance of the teeth, at least until the coating layer has been rubbed off by the sawing action.

Similar considerations can be taken into account for luminescent layers applied to other tools. For instance, most of the exposed surface of a drill bit is a working surface and is subject to friction during a drilling operation. In some cases, the root of the flutes of the bit can include the luminescent layer, since the flutes may not be subjected to as much friction as the cutting edge of the flutes. Alternatively, the luminescent layer can be applied only at the proximal end of the bit where it is mounted within the chuck of the power drill. With this approach, the layer can provide a visual reference point for the depth of the bore into the structure.

In an alternative embodiment, as depicted in FIG. 4, a saw blade 40 can include a blade surface 42 that is substantially free of the luminescent coating. However, a luminescent layer can be provided at discrete locations 44 and 46. The locations 44 and 46 can constitute lettering, symbols or other indicia, or can be simply in the form of position indicator strips. In addition, a luminescent strip 48 can be provided at the end of the blade 40. The combination of each of the luminescent portions 44, 46, and 48 can allow the saw operator to visualize the positioning and orientation of the saw blade 40.

Whether the working portion of the rescue tool is substantially covered by a luminescent layer, such as blade 30, or covered in limited regions, such as the blade 40, the luminescent material acts as a visual guide for the rescue worker. Not only does the material help the worker orient and position the tool, it also helps the worker visualize the tool operation. For instance, where only a limited space is available for use of a saw, the rescue worker can determine when to limit the stroke of the blade to avoid contacting adjacent structure or even the victim to be extracted.

To the extent that the luminescent coating is capable of illuminating the work site, the greater extent of the coating the better. Thus, the embodiment of FIG. 3 can be preferred where the coating 35 covers substantially the entire saw blade 30. On the other hand, where self-illumination is not as critical, the luminescent material can be applied to limited locations of the blade, such as the blade 40 in FIG. 4. It is understood that the blades 30 and 40 illustrated in FIGS. 3 and 4 are typical of one type of saw blade. Other saw blades and blade configurations can include the same or similar luminous coating. Moreover, in the case of the sword saw 10 in FIG. 1, the sword shield 14 can include a luminous coating to help the operator to distinguish the limits of a cutting blade 12. Likewise, the extent and positioning of luminous layers on other types of tools can be dictated by the expected usage of the tool.

In accordance with the present invention, the luminous coating can be chosen from a variety of materials. For instance, the coating may be fluorescent or phosphorescent. In general, a fluorescent coating requires some ambient light to illuminate the fluorescent material within the coating. On the other hand, a phosphorescent material is self-emitting, so that the material glows for a predetermined amount of time in the absence of a separate light source.

In the most preferred embodiment, the luminescent layer, such as layer 35 of FIG. 3, includes a phosphorescent material, such as zinc sulfide. Moreover, most preferably the phosphorescent material is incorporated into binder, such as an enamel or a lacquer liquid that can be applied to the surface of the blade. In one process, a water diluted lacquer containing phosphorescent pigment or crystals is spray painted onto a working portion of a tool, such as a saw blade, with an automatic spray gun. Alternatively, an electrostatic procedure can be utilized in which an electrostatic charge is applied to the working portion to cause the lacquer and phosphorescent material to adhere to the surface of the blade. Other methods for applying the phosphorescent layer are contemplated by the invention, such as by dipping the entire tool or blade into a vat of the material. In some instances, a separate exterior layer, such as a transparent overcoat, may be applied to help protect the luminescent material.

The lacquer or enamel phosphorescent layer has a sufficient thickness to exhibit sufficient luminosity so that the worker can readily discern the outlines of the tool even in a pitch-black environment. Moreover, the thickness of the layer can be dictated by the particular luminescent material. Some materials utilize luminescent crystals that require a certain thickness of binder material to completely entrain the crystals. In a specific embodiment, a lacquer layer is applied on all surfaces of the cutting blade 30 to a thickness of 10-30 micrometers (μm). The lacquer material is preferably capable of adhering to a wide range of tool materials, including iron and aluminum.

In one specific embodiment, the luminescent material can include a super-phosphorescent material, such as strontium. It is known that strontium is a self-emitting light material that has a glow time of in excess of twelve hours, depending upon the color of the super-phosphorescent layer. Most preferably, the color is a green or yellow-green to exhibit the greatest degree of visibility for the longest period of time. In addition, the yellow-green luminous material provides some illumination of the work site.

While the most preferred embodiment of the invention contemplates a single color for the blade, such as yellow or yellow-green a variety of color schemes can be implemented. For instance, one color can be applied at the working tip of the tool, while a different color can be applied at the engagement end of the tool. Thus, the operator is provided with a direct and immediate visual indication of the specific orientation of the blade.

In the most preferred embodiment of the invention, the luminescent layer is phosphorescent. A phosphorescent material is photo-luminescent, meaning that the phosphorescent particles reach their excited state by application of light. With a phosphorescent layer on the working portion of a tool, the tool needs to be exposed to light for a sufficient period of time to energize the entirety of the layer. Thus, it is contemplated that where the luminescent tools of the present invention are to used in rescue missions, the blades are stored in a lighted location, and most preferably in a location that is lighted twenty four hours a day. With this storage protocol, the phosphorescent material will be constantly energized and re-energized in anticipation of use at a low-light or pitch-black accident or victim extraction site.

The luminescent part of the working tool can be removable from the driving or powered portion of the tool. In the illustrated examples, the saw blade is removable from the powered hand-held saw. The removable working portion simplifies storage and exposure to light to energize the luminescent material. Moreover, a plurality of removable working elements can be carried to an accident site so that when the luminescence fades for one removable element, a replacement can be engaged to the power tool that is “fully charged”. With this approach, the luminescent material need not be capable of the maximum duration possible. In other words, while super-phosphorescent materials are available that remain illuminated for up to 12 hours, other phosphorescent materials may be sufficient that endure for only a couple of hours, so long as charged replacements are available.

Alternatively, the luminescent material can be fluorescent, which means that is glows only when subject to energizing radiation. A fluorescent material returns to its ground state very rapidly, thus necessitating constant external excitation. For that reason, a fluorescent material would not be desirable where the work site is dark or has very low light. On the other hand, under certain lighting conditions, a fluorescent material will glow sufficiently to help the rescue worker easily identify the outline of the cutting blade. For that matter, a fluorescent layer can provide benefits even under normal daytime lighting conditions to help the rescue worker more easily visualize the tool while it is being used.

The invention also contemplates other types of luminescent materials that are energized under different conditions. For instance, a triboluminescent material emits light while absorbing mechanical energy. A material of this type would essentially emit light only when the tool is being used. The mechanical stress or strain experienced by the tool can provide sufficient mechanical energy to activate some triboluminescent materials. Likewise, a thermo-luminescent material, which emits light while absorbing heat energy, can be used to illuminate the blade as it heats up by the cutting friction. Although possibly less desirable, the blade itself can be treated like an electrode and heated by application of a low level electrical current to the blade, to thereby activate the thermo-luminescent material.

The present invention contemplates applying a luminescent layer to a tool for use at a darkened or low light work site. Preferably, the tool is a rescue tool, such as a saw used for cutting through a collapsed structural elements. Moreover, the luminescent material not only glows to provide a visual indication of the extent, location, and positioning of the tool, but also is sufficiently luminous to provide some minimal lighting at the work site.

Most preferably, the luminescent material is a phosphorescent material that can be energized by light and that glows for a considerable period of time. Alternatively, a fluorescent material can be utilized where light exists at the work site but at a very low level. With either type of luminescent material, an important object is to provide the rescue worker with a direct a visual indication of the location and orientation of the working tool at the working site and even while the tool is in use.

This feature of the invention will allow the rescue worker to make more efficient use of the tool during a difficult rescue extraction of a trapped victim. In addition, the direct visualization of the tool, even in total darkness, can help guide the worker in using the tool so as to avoid adjacent structure and even the victim. Moreover, the luminescent rescue working tool can allow a rescue worker to perform extraction operations where they could not be performed before—i.e., where the extraction site is shrouded in darkness and there is no access for providing secondary lighting.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A power saw assembly, comprising:
a power saw operable to reciprocate a power saw coupling; and
a saw blade attached to said power saw coupling, said saw blade having cutting teeth,
a layer of luminescent material applied to said saw blade.

2. The power saw assembly of claim 1, wherein:
said saw blade includes a first side surface and a second side surface, and
said layer of luminescent material is applied to the entirety of both said first side surface and said second side surface.

3. The power saw assembly of claim 1, wherein:
said saw blade includes a first side surface, and
at least a portion of said first side surface is free of said layer of luminescent material.

4. The power saw assembly of claim 1, wherein said layer of luminescent material is applied to a side surface of said saw blade to form lettering thereon.

5. The power saw assembly of claim 1, wherein said layer of luminescent material is applied to a side surface of said saw blade to form at least one symbol thereon.

6. The power saw assembly of claim 1, wherein said luminescent material is a phosphorescent material.

7. The power saw assembly of claim 1, wherein said luminescent material is a super-phosphorescent material.

8. The power saw assembly of claim 1, wherein said luminescent material is a fluorescent material.

9. A power tool assembly, comprising:
a power tool operable to move a power tool coupling in a repeating pattern;
a work piece contacting member attached to said power tool coupling, said work piece contacting member being moved in said repeating pattern during operation of said power tool; and
a layer of luminescent material applied to said work piece contacting member.

10. The power tool assembly of claim 9, wherein:
said power tool is a power drill, and
said work piece contacting member is a drill bit.

11. The power tool assembly of claim 10, wherein:
said drill bit possesses at least one flute, and
said layer of luminescent material is located within said at least one flute.

12. The power tool assembly of claim 9, wherein:
said power tool is a power saw, and
said work piece contacting member is a saw blade.

13. The power tool assembly of claim 12, wherein said power saw is operable to reciprocate said power saw coupling.

14. The power tool assembly of claim 9, wherein:
said work piece contacting member includes a first side surface and a second side surface, and
said layer of luminescent material is applied to the entirety of both said first side surface and said second side surface.

15. The power tool assembly of claim 9, wherein:
said work piece contacting member includes a first side surface, and
at least a portion of said first side surface is free of said layer of luminescent material.

16. The power tool assembly of claim 9, wherein said layer of luminescent material is applied to a side surface of said work piece contacting member to form lettering thereon.

17. The power tool assembly of claim 9, wherein said layer of luminescent material is applied to a side surface of said work piece contacting member to form at least one symbol thereon.

18. The power saw assembly of claim 9, wherein said luminescent material is a phosphorescent material.

19. The power tool assembly of claim 9, wherein said luminescent material is a super-phosphorescent material.

20. The power tool assembly of claim 9, wherein said luminescent material is a fluorescent material.

21. A method of using a power saw assembly in a rescue situation, comprising the steps of:
providing said power saw assembly having (i) a power saw operable to reciprocate a power saw coupling, (ii) a saw blade attached to said power saw coupling, said saw blade having cutting teeth, and (iii) a layer of luminescent material applied to said saw blade; and
operating said power saw assembly in a light deprived location so as to free a victim trapped in a damaged structure.

22. The method of claim 21, further comprising the step of storing said saw blade in a location that is maintained in a lit condition on a twenty-four hour per day basis prior to said operating step.

23. A method of using a power tool assembly in a rescue situation, comprising the steps of:
providing said power tool assembly having (i) a workpiece contacting member, (ii) a power tool operable to move said workpiece contacting member in a repeating pattern, and (iii) a layer of luminescent material applied to said work piece contacting member; and
operating said power tool assembly in a light deprived location so as to free a victim trapped in a damaged structure.

24. The method of claim 23, further comprising the step of storing at least said workpiece contacting portion of said power saw assembly in a location that is maintained in a lit condition on a twenty-four hour per day basis prior to said operating step.

25. A power tool assembly, comprising:
a workpiece contacting member;
a power tool operable to move said workpiece contacting member in a repeating pattern; and
a layer of luminescent material applied to said work piece contacting member.

26. The power tool assembly of claim 25, wherein:
said workpiece contacting member includes a first side surface and a second side surface, and
said layer of luminescent material is applied to the entirety of both said first side surface and said second side surface.

27. The power tool assembly of claim 25, wherein:
said workpiece contacting member includes a first side surface, and
at least a portion of said first side surface is free of said layer of luminescent material.

28. The power tool assembly of claim 25, wherein said layer of luminescent material is applied to a side surface of said workpiece contacting member to form lettering thereon.

29. The power tool assembly of claim 25, wherein said layer of luminescent material is applied to a side surface of said workpiece contacting member to form at least one symbol thereon.

30. The power tool assembly of claim 25, wherein said luminescent material is a phosphorescent material.

31. The power tool assembly of claim 25, wherein said luminescent material is a super-phosphorescent material.

32. The power tool assembly of claim 25, wherein said luminescent material is a fluorescent material.
